(19) United States
(12) Patent Application Publication
(10) Pub. No.: US 2017/0085076 A1
(43) Pub. Date: Mar. 23, 2017

(54) SETTING AND COORDINATION CALCULATION METHOD FOR PROTECTION SETTING VALUE OF DC SYSTEM

(71) Applicants: XJ GROUP CORPORATION, Xuchang (CN); XJ ELECTRIC CO.,LTD, Xuchang (CN); STATE GRID CORPORATION OF CHINA, Beijing (CN)

(72) Inventors: Hongyue Zhang, Xuchang (CN); Zhenhua Zhang, Xuchang (CN); Hailong Chen, Xuchang (CN); Ganjie Chen, Xuchang (CN); Kun Zhang, Xuchang (CN); Yujie Xu, Xuchang (CN); Yanhui Du, Xuchang (CN); Zhenyu Lu, Xuchang (CN); Zhilei Niu, Xuchang (CN); Youbin An, Xuchang (CN); Yanru Zhao, Xuchang (CN); Shaohui Huang, Xuchang (CN)

(73) Assignees: XJ GROUP CORPORATION; XJ ELECTRIC CO.,LTD

(21) Appl. No.: 15/076,268

(22) Filed: Mar. 21, 2016

(30) Foreign Application Priority Data
Sep. 23, 2015 (CN) 201510613348.2

(51) Int. Cl. H02H 1/00; G06F 17/50

(52) U.S. Cl. CPC H02H 1/0092; G06F 17/5009; G06F 2217/16

(57) ABSTRACT

A setting and coordination calculation method for protection setting value of DC system is introduced. A protective template library is built by classifying the DC system protections to various protective areas and classifying each protective area. Based on project configuration, a mathematical model of converter station is built, the parameters of equipment components and locations of short circuit are given. The short-circuit current value and the parameters of equipment component are regarded as process parameters during the setting and coordination. The electromagnetic transient simulation is carried out at first in this method. And a specified and standard project of the setting and coordination is formed by abstracting and standardizing the process of the setting and coordination, which makes present setting and coordination of DC transmission engineering independent of the electromagnetic transient simulation software. This ensures the rationality of the protection setting value, reduces protection operation-failure or malfunction of the system.

### TECHNICAL FIELD

The present invention relates to a field of relay protection of electric power system and belongs to computer software technology, and more particularly relates to a setting and coordination calculation method for protection setting value of DC system.

### BACKGROUND

The setting and coordination for the protection setting value of DC system in the field of DC transmission needs to consider several factors, such as fault characteristics, equipment's tolerance, setting cooperation and cooperation with DC control system. Due to the DC transmission system having strong nonlinear feature, a limit value, such as maximum value and minimum value of short-circuit current, of fault parameters which is required for calculating the protection setting value of DC system is very difficult to obtain through fault analysis algorithm Therefore, the protection setting value calculation of DC system in the present DC transmission engineering is carried out by the electromagnetic transient simulation software which performs simulation repeatedly in enumerative, which is lack of theoretical analysis. The protection setting value calculation method carried out by the electromagnetic transient simulation is dependent on the researchers' experience due to being lack of standard guidelines when setting the fault simulation conditions. It has questions, such as the large amount of the simulation and missing some fault limit value, which influences the rationality of the protection setting value, and has protection operation-failure or malfunction of the system. Besides, the principles of protection of DC transmission system and the methods of setting and coordination DC power transmission suppliers used are not the same.

In summary, the protection setting value of DC system for traditional DC transmission field is firstly given in the program and verifies the accuracy by simulation software. The protection setting value is reset through modifying the program when value is not reasonable, which is time-consuming, laborious and low efficiency.

### SUMMARY OF THE INVENTION

The present invention provides a setting and coordination calculation method for protection setting value of DC system. This method overcomes defects of time-consuming, laborious and low efficiency of the existing technology.

The present invention provides a setting and coordination calculation method for protection setting value of DC system for the above technology problem, which includes the following steps:
1) Classifying DC system protections to various protective areas, which comprise a converter protective area, a electrode protective area, a bipolar protective area, a DC filter protective area, a converter transformer protective area, and a AC filter and AC busbar protective area;
2) Classifying each protective area to build a corresponding protective template library which includes differential protective templates, overload protective templates, and switching device protective templates;
3) Building a mathematical model of the converter station through project configuration, and setting parameters of equipment components and locations of short circuit;
4) Carrying out electromagnetic transient simulation study of the mathematical model of the converter station and calculating the current value of short-circuit;
5) Putting the current value of short-circuit and parameters of equipment components into a corresponding protective template, which is one protective template of the protective template library of 2^{nd} step and carrying out the setting and coordination according to classification principle of the DC system to obtain the protection setting value.

The method classifies DC system protections to DC line protection, differential protection, overload protection and switching device protection, as indicating in 2^{nd} step.

The protection setting value of the setting and coordination calculation will be recalculated when it is unsuitable until the protection setting value meets the requirements according to 5th step.

The protection setting value of the setting and coordination calculation is accepted when it meets the requirement and generates a setting list and a setting document.

The setting list meets the provision of the technical specification of setting for controlling and protection in HVDC system, which is a China's industry standard.

The advantages of the invention are as follows: a protective template library is built by classifying DC system protections into various protective areas and classifying each protective area, wherein the protective template library includes differential protective template, overload protective template and switching device protective template. There are twenty three types of protective templates. A mathematical model is built by project configuration and the parameters of equipment components and locations of short circuit are given. The short-circuit current value is obtained by the electromagnetic transient simulation, which is regarded as the process parameters. Then, carry out the setting and coordination with the obtained the short-circuit current values and parameters of equipment components. The basis of the invention is the principle of the setting and coordination and computer software technology. The electromagnetic transient simulation is carried out at first in this invention. And a specified and standard project of the setting and coordination is formed by abstracting and standardizing the process of the setting and coordination, which makes present setting and coordination of DC transmission engineering independent of the electromagnetic transient simulation software. This ensures the rationality of the setting protection value, reduces protection operation-failure or malfunction of the system, which is very good for improving the automation level of power system.

### BRIEF DESCRIPTION OF THE DRAWINGS

FIG. 1 is a schematic diagram of the classification of DC system protections;

FIG. 2 is a schematic diagram of the project configuration of the converter station;

FIG. 3 is a flow diagram of automatic setting and coordination calculation for protection setting value of DC system.

### DETAILED DESCRIPTION

Detailed description of the invention with the drawings is given in the following.

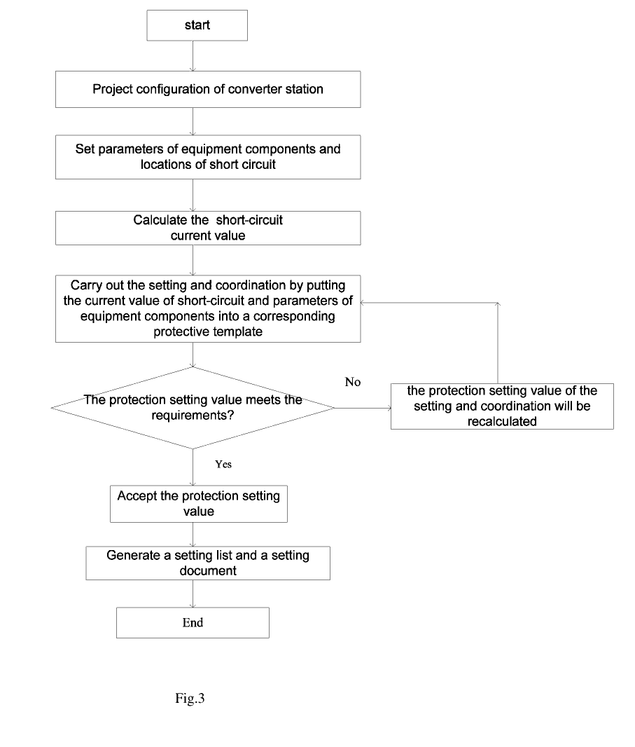

The protection setting value of DC system for traditional DC transmission field is firstly given in the program and verifies the accuracy by simulation software. The protection setting value is reset through modifying the program when value is not reasonable, which is time-consuming, laborious and low efficiency. This invention provides a setting and coordination calculation method for protection setting value of DC system. As indicated FIG. 3, a mathematical model is built by project configuration and the parameters of equipment components and locations of short circuit are given. Then, a lot of electromagnetic transient simulation is carried out by the system automatically. The value of short-circuit current is confirmed by the electromagnetic transient simulation. The short-circuit current value and the parameters of equipment component are regarded as process parameters during setting and coordination calculation. And the protection setting value will be recalculated when it is unsuitable until the protection setting value meets the requirements. If the protection setting value of the setting and coordination meets the requirement, accept it.

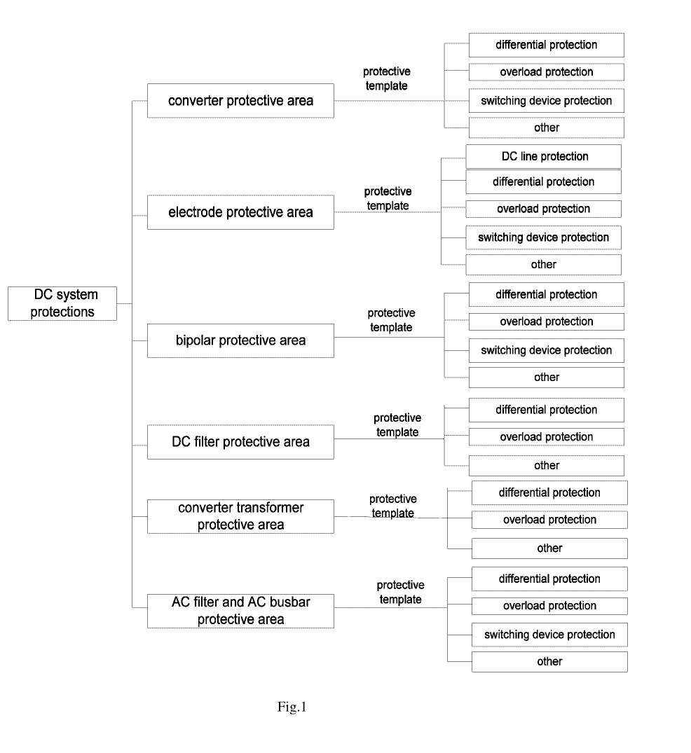

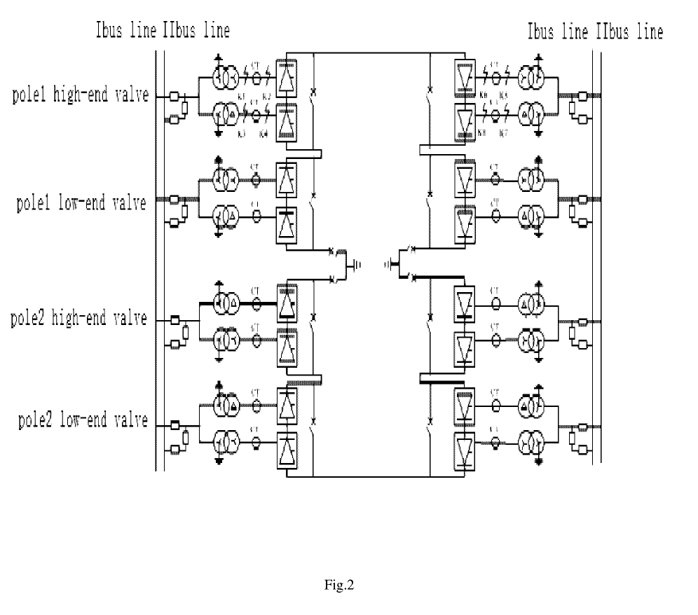

The basis of the setting and coordination calculation method is the principle of the setting and coordination and computer software technology. The electromagnetic transient simulation is carried out at first in this method. The setting and coordination document for DC system, which meets the criterion in the field of DC system, is formed. Detailed description of the invention is given in the following:
1. The DC system protections consists of six protective areas, i.e., a converter protective area, a electrode protective area (including the DC transmission line), a bipolar protective area, a DC filter protective area, a converter transformer protective area, a alternating current (AC) filter and AC busbar protective area. As indicated by FIG. 1, a protective template library consists of twenty-three protective templates, which includes differential protective template, overload protective template and switching device protective template, and so on. It is easy to obtain the reasonable protection setting value by classifying the protection for DC system into different areas.
2. An equipment components library is formed, and a mathematical model of converter station is built automatically in the process of the project configuration for converter station. The parameters of equipment components, such as rated power, rated voltage and locations of short circuit, are managed. As indicated by FIG. 2, a complete set of equipment components is provided, the mathematical model of converter station is built automatically, which includes connection relationship between equipments, settings of locations of short circuit, and DC running form of converter stations.
3. The short-circuit current value of the setting and coordination calculation in DC system is obtained by calculation of the fault calculation modules.
4. Put the current value of short-circuit and parameters of equipment components into a corresponding protective template, which is one protective template of the protective template library of 2^{nd} step and carry out the setting and coordination calculation according to classification principle of the DC system and obtain the protection setting value.
5. When the setting and coordination is ended, the protection setting value of setting and coordination for DC system is output, the protection setting value includes setting list and setting document. The setting list meets the provision of the technical specification of setting for controlling and protection in HVDC system, which is a China's industry standard.

The correction and validation of the method is verified with a certain DC line protection. The parameters of the simulation model are as shown in table 1.

TABLE 1
Parameters of the simulation model

| | Rated | Rated | Line | |
|---|---|---|---|---|
| Rated capacity | voltage | current | length | Fault duration |
| Bipolar 6400 MW | ±800 kV | 4 kA | 1907 km | 0.1 ms |

The fault information value is determined according to protection criterion. The protection setting value is greatly influenced by high resistance earth fault at the end of transmission line in seven cases (transmission line 60%, transmission line 80%, transmission line 100%, 100Ω Grounding Resistance).

Therefore, the fault information value in these cases is determined through setting and coordination software, as shown by table 2.

TABLE 2
Comparison table between protection setting value by calculation and
protection setting value by running

| | Protection setting | Protection setting |
|---|---|---|
| | value by calculation | value by running |
| Polar wave transformation rate | 196 kV | 200 kV |
| criterion (full voltage) | | |
| Polar wave transformation rate | 104.8 kV | 100 kV |
| criterion (Non full voltage) | | |
| Voltage variation criterion | 0.92 p.u. | 0.95 p.u. |

As indicated by table 2, the two values are substantially the same.

In summary, based on specified process of present DC transmission engineering, computer software technology, standard process of the setting and coordination, new software for the setting and coordination calculation of the DC transmission engineering field is formed. This ensures the rationality of the setting protection value, reduces protection operation-failure or malfunction of the system, which is very good for improving the automation level of power system.

What is claimed is:

1. A setting and coordination calculation method for protection setting value of DC system, including the following steps:
1) classifying DC system protections to various protective areas, which comprise a converter protective area, a electrode protective area, a bipolar protective area, a DC filter protective area, a converter transformer protective area, and a AC filter and AC busbar protective area;
2) classifying each protective area to build a corresponding protective template library which includes differential protective templates, overload protective templates, and switching device protective templates;
3) building a mathematical model of the converter station through project configuration, and setting parameters of equipment components and locations of short circuit;
4) carrying out electromagnetic transient simulation study of the mathematical model of the converter station and calculating the current value of short-circuit; and
5) putting the current value of short-circuit and parameters of equipment components into a corresponding protective template, which is one protective template of the protective template library of 2^{nd} step and carrying out the setting and coordination according to classification principle of the DC system to obtain the protection setting value.

2. The setting and coordination calculation method for protection setting value of DC system of claim 1, characterized in that: the method classifies DC system protections to DC line protection, differential protection, overload protection and switching device protection, as indicating in 2^{nd} step.

3. The setting and coordination calculation method for protection setting value of DC system of claim 2, characterized in that: the protection setting value of the setting and coordination calculation will be recalculated when it is unsuitable until the protection setting value meets the requirements according to 5^{th} step.

4. The setting and coordination calculation method for protection setting value of DC system of claim 3, characterized in that: the protection setting value of the setting and coordination calculation is accepted when it meets the requirement and generates a setting list and a setting document.

5. The setting and coordination calculation method for protection setting value of DC system of claim 4, characterized in that: the setting list meets the provision of the technical specification of setting for controlling and protection in HVDC system, which is a China's industry standard.
